(19) United States
(12) Patent Application Publication
(10) Pub. No.: US 2013/0007061 A1
(43) Pub. Date: Jan. 3, 2013

(54) APPARATUS AND ASSOCIATED METHODS

(75) Inventors: Petri Luomala, Oulu (FI); Janne Kyllönen, Kiviniemi (FI); Ashley Colley, Oulu (FI)

(73) Assignee: NOKIA CORPORATION, Espoo (FI)

(21) Appl. No.: 13/172,601

(22) Filed: Jun. 29, 2011

(51) Int. Cl. G06F 17/30

(52) U.S. Cl. 707/776; 707/E17.143

(57) ABSTRACT

In one or more embodiments described herein, there is provided an apparatus having a processor, and at least one memory including computer program code. The memory and the computer program code are configured to, with the at least one processor, cause the apparatus to perform the following. Firstly, the apparatus is caused to identify, based on received gesture command signalling associated with two or more content items, one or more common aspects of metadata for those two or more content items. Secondly, the apparatus is caused to use an identified common aspect of said metadata to search for other content items with metadata in common to the identified common aspect of metadata.

### TECHNICAL FIELD

The present disclosure relates to the field of content searching, associated methods, computer programs and apparatus, particularly those associated with touch or touch-sensitive user interfaces. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs). Also, portable electronic devices can be considered to include tablet computers.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect, there is provided an apparatus comprising:
at least one processor; and
at least one memory including computer program code,
the at least one memory and the computer program code being configured to, with the at least one processor, cause the apparatus to perform at least the following:
identify, based on received gesture command signalling associated with two or more content items, one or more common aspects of metadata for those two or more content items; and
use an identified common aspect of said metadata to search for other content items with metadata in common to the identified common aspect of metadata.

Content items may comprise one or more of:
text files, image files, audio files, video files, content hyperlinks, shortcut links, files particular to specific software, non-specific file types and the like.

Metadata may comprise one or more types of information relating to the content items in question. The metadata may constitute any information that is useable for the purposes of conducting a search or performing categorisation of content items. Metadata aspects may comprise actual metadata tag categories, or content within actual metadata tag categories, or the like.

Metadata tag categories may be one or more selected from the group:
names, titles, tags, artists, albums, people, group, originating program, originating author, last modified date, created date, last moved date, modification history, modified by who, created by who, moved by who, sender(s), receiver(s), and geo-tags or the like.

The common metadata aspect used for the search may be the common metadata content across the same common metadata tag category of the two or more content items. The common metadata aspect used for the search may be the common metadata content across one or more metadata tag categories of the two or more content items.

The common metadata aspect used for the search may be the common metadata content across one or more of the same and different metadata tag categories of the two or more content items. The common metadata aspect used for the search may be the common metadata content across one or more metadata tag categories of the two or more content items together with the corresponding metadata tag categories.

The at least one memory and the computer program code may be configured to, with the at least one processor, cause the apparatus to:
provide user access to the other content items with metadata in common to the identified common aspect of metadata.

User access may comprise at least displaying of said one or more other content items.

The at least one memory and the computer program code may be configured to, with the at least one processor, cause the apparatus to:
use the identified common aspect of metadata to perform filter searching of metadata of other content items to identify other content items with metadata in common to the identified common aspect of metadata.

Using the identified common aspect of metadata to perform filter searching of metadata of other content items to identify other content items with metadata in common to the identified common aspect of metadata thereby provides for user access to other content items with metadata in common to the identified common aspect of metadata.

The at least one memory and the computer program code may be configured to, with the at least one processor, cause the apparatus to:
in response to multiple common metadata aspects being identified for the two or more content items, provide the user with the opportunity to select a particular common metadata aspect for use in the search, and use the selected common metadata aspect as the identified common aspect of metadata to search for other content items with metadata in common to the identified common metadata aspect.

The search may be conducted on content items to which the apparatus has access.

The search may be limited to being conducted in a container that is directly/indirectly associated with the two or more content items.

A container may represent one or more of: a folder within which a plurality of content items are stored, related folders, any folder that is a given number of folder levels above a particular container folder in a system hierarchy, a My Pictures/My Videos folder (or other personal content folder), etc.

The search may be limited to being conducted in the particular container containing the two or more content items.

The at least one memory and the computer program code may be configured to, with the at least one processor, cause the apparatus to:
perform a particular type of searching associated with the particular gesture command signalling to provide for user access to other content items with metadata in common to the identified common aspects of metadata.

The at least one memory and the computer program code may be configured to, with the at least one processor, cause the apparatus to:
perform a predetermined type of searching to provide for user access to other content items with metadata in common to the identified common aspects of metadata in the event that particular gesture command signalling does not have a particular type of searching associated therewith.

The predetermined search type may be: AND, OR, NOR, NAND, within the current container/folder, within the current container/folder and any sub-folder thereof, within the whole storage device, within a certain number of levels away from the current container/folder in the hierarchy, etc.

Particular gesture signalling may be associated with: different logical operations, different folders, etc.

The displayed other content items may also be useable for further selection and/or further searching.

The gestural signalling may generated by a touch-sensitive display of an electronic device in response to a user operating said touch-sensitive display

The at least one memory and the computer program code may be configured to, with the at least one processor, cause the apparatus to:
receive gesture command signalling from a touch-sensitive display of an electronic device, the gesture command signalling being generated in response to a user operating said touch-sensitive display.

The other content items provided by the search may be provided on the same or different user interface as that which received the gesture command

The apparatus may ask for user confirmation of the search to be performed prior to actually performing the search.

The gesture may be a multi-touch operation involving: one, two, three, four or more fingers; and the multi-touch may be in combination with one or more actions of: swipe, clockwise or anticlockwise circle or swirl, tap, double tap, triple tap, rotate, slide, pinch, push, reverse pinch, etc.

The apparatus of claim 1, wherein the apparatus is one or more of:
an electronic device, a portable electronic device, a module for an electronic device, and a module for a portable electronic device.

In another aspect, there is provided a method, comprising:
identifying, based on received gesture command signalling associated with two or more content items, one or more common aspects of metadata for those two or more content items; and
using an identified common aspect of said metadata to search for other content items with metadata in common to the identified common aspect of metadata.

In another aspect, there is provided a non-transitory computer readable medium, comprising computer program code stored thereon, the computer program code being configured to, when run on at least one processor, perform at least the following:
identifying, based on received gesture command signalling associated with two or more content items, one or more common aspects of metadata for those two or more content items; and
using an identified common aspect of said metadata to search for other content items with metadata in common to the identified common aspect of metadata.

In another aspect, there is provided an apparatus, comprising:
means for identifying configured to identify, based on received gesture command signalling associated with two or more content items, one or more common aspects of metadata for those two or more content items; and
means for searching configured to use an identified common aspect of said metadata to search for other content items with metadata in common to the identified common aspect of metadata.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

References to a single “processor” or a single “memory” can be understood to encompass embodiments where multiple “processors” or multiple “memories” are used.

The above summary is intended to be merely exemplary and non-limiting.

### BRIEF DESCRIPTION OF THE FIGURES

A description is now given, by way of example only, with reference to the accompanying drawings, in which:—

FIGS. 1a and 1b show example devices.

FIGS. 2a and 2b show other example devices.

FIG. 3 shows an apparatus described herein.

FIGS. 4a and 4b show one embodiment according to the present disclosure.

FIGS. 5a-c show another embodiment of the present disclosure.

FIGS. 6a-c show another embodiment of the present disclosure.

FIGS. 7a-c show another embodiment of the present disclosure.

FIG. 8 shows a method.

FIG. 9 shows another embodiment of the present disclosure.

FIG. 10 illustrates schematically a computer readable media providing a program according to an embodiment of the present invention.

### DESCRIPTION OF EXAMPLE ASPECTS/EMBODIMENTS

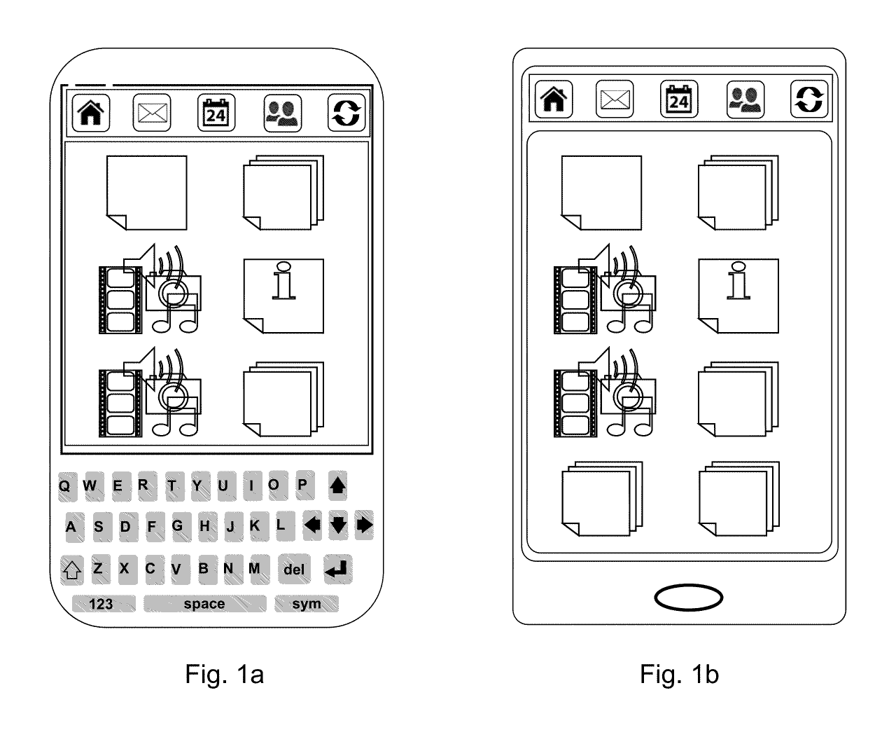

There are many different types of electronic device available to the public today. For example, portable devices come as laptops, touch-screen tablet personal computers (PC), mobile phones with touch-screens (see FIG. 1b) and mobile phones without touch-screens (see FIG. 1a), portable music/MP3 players and the like. These devices have various feature sets depending on their size and intended application. For example, laptops tend to have more memory for file storage than tablet PCs, and tablet PCs tend to have more memory for file storage than mobile phones. However, MP3 players while being around the same size as mobile phones are generally configured to have more memory for file storage than mobile phones.

With small portable devices or devices with a lot of user content (or content which is frequently updated or added to), users can sometimes find it hard or at least cumbersome to locate a particular file that is stored on that particular device.

For example, FIGS. 1a and 1b each show mobile devices where a user is browsing the main storage memory of the device to find a file. The device of FIG. 1a is a non-touch-screen device that has its own dedicated QWERTY keypad for user input and control of the device. The device of FIG. 1b is a touch-screen device where a user interacts directly with the screen using their fingers or a stylus to control the user input.

Typically when users are viewing folders with files or storage drives/compartments on such devices, these files are rendered onscreen as thumbnail icons, though they can often be configured to be presented as a list or to be presented in other ways.

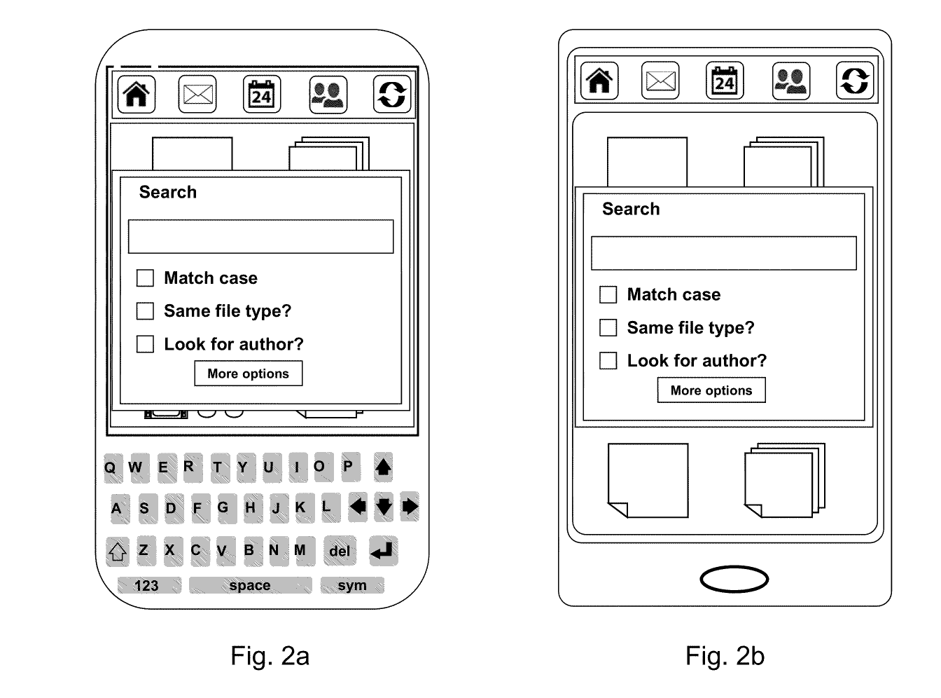

If a user wishes to find a file, they typically navigate to a menu and select the ‘search’ option from that menu. For example, in many PC operating systems there is a menu bar at the top of the screen with drop-down menus that allow users to select options. If a user selects a ‘search’ option on such devices, this typically results in a pop-up dialog box being presented onscreen. FIG. 2a shows a dialog box having been brought up in the device of FIG. 1a, and FIG. 2b shows a dialog box having been brought up in the device of FIG. 1b. This dialog box either obscures some of the icons underneath or fills the screen completely.

The dialog box allows a user to enter search string text that is to be looked for across the files. Now, many files have hidden attributes other than the normally visible file name. For example, the files have metadata that stores related information about the file. For example, metadata is normally subdivided into categories of metadata tags, such as the author, date of creation, last date modified, etc. The specific metadata information is stored as the ‘content’ of these tags, e.g. ‘author’ is the tag, and ‘James Owen’ is the content of the tag. In the case of music files, for example, there are typically further tags for artist, album, genre, etc. Most search functions consider these metadata tags and their content when performing string searches.

As can be seen in FIGS. 2a and 2b, there are checkboxes that the user can select/not select to further modify and/or refine the search. For example, if the user selects the ‘case sensitive’ check box then the search must only return results that exactly match the spelling and case of the search string text. The other checkboxes also affect the search in different ways, and there are of course more options well known in the art for further refining searches beyond merely searching for text in file names or file attributes.

However, navigating to this search dialog box is an added menu step beyond directly browsing a folder or set of files, and can (depending on the nature of the operating system and the user interface of the device in question) often be an involved process that is not necessarily very easy or even intuitive for users. Another difficulty with these examples is that the dialog box can obscure or completely cover the graphical representation of the files the user is wishing to navigate. This can make it harder for the user to truly see what it is they are searching through, and the users can sometimes feel disconnected from the file system whilst trying to search for a specific file or folder. One or more embodiments described herein can help alleviate one or more of these difficulties.

In one or more embodiments described herein, there is provided an apparatus having a processor, and at least one memory including computer program code. The memory and the computer program code are configured to, with the at least one processor, cause the apparatus to perform the following. Firstly, the apparatus is caused to identify, based on received gesture command signalling associated with two or more content items, one or more common aspects of metadata for those two or more content items. Secondly, the apparatus is caused to use an identified common aspect of said metadata to search for other content items with metadata in common to the identified common aspect of metadata.

In the present disclosure, metadata can be understood to comprise one or more types of information relating to content items in question (e.g. metacontent or descriptive metadata). For example, metadata can encompass or constitute any information that is useable for the purposes of conducting a search or performing categorisation of content items. Metadata aspects may comprise actual metadata tag categories, or content within actual metadata tag categories, or the like. This is discussed in more detail below.

In essence, in the above example the user has touched two or more content items (e.g. files, or graphical representations/icons for shortcuts or files, or even folders) presented onscreen. The touch was performed in a particular way so as to constitute gesture command signalling (i.e. the user performs a distinct gesture or multi-touch operation on a device having a touch-sensitive display). In response to this gesture command signalling, the apparatus is caused to identify metadata that is common between those content items that were indicated in relation to the gesture command signalling (for example, that two files both have a metadata tag, like ‘location’, that contains the content/metadata word ‘Paris’—the common metadata aspect would therefore be at least the metadata ‘Paris’). Once the common metadata aspect is identified, the apparatus can then perform a search for other content items with the same metadata in common to the originally designated content items. By doing this, a user is able to directly interact with content presented onscreen to find other like content without having to enter a menu or dialog box before the search can be initiated.

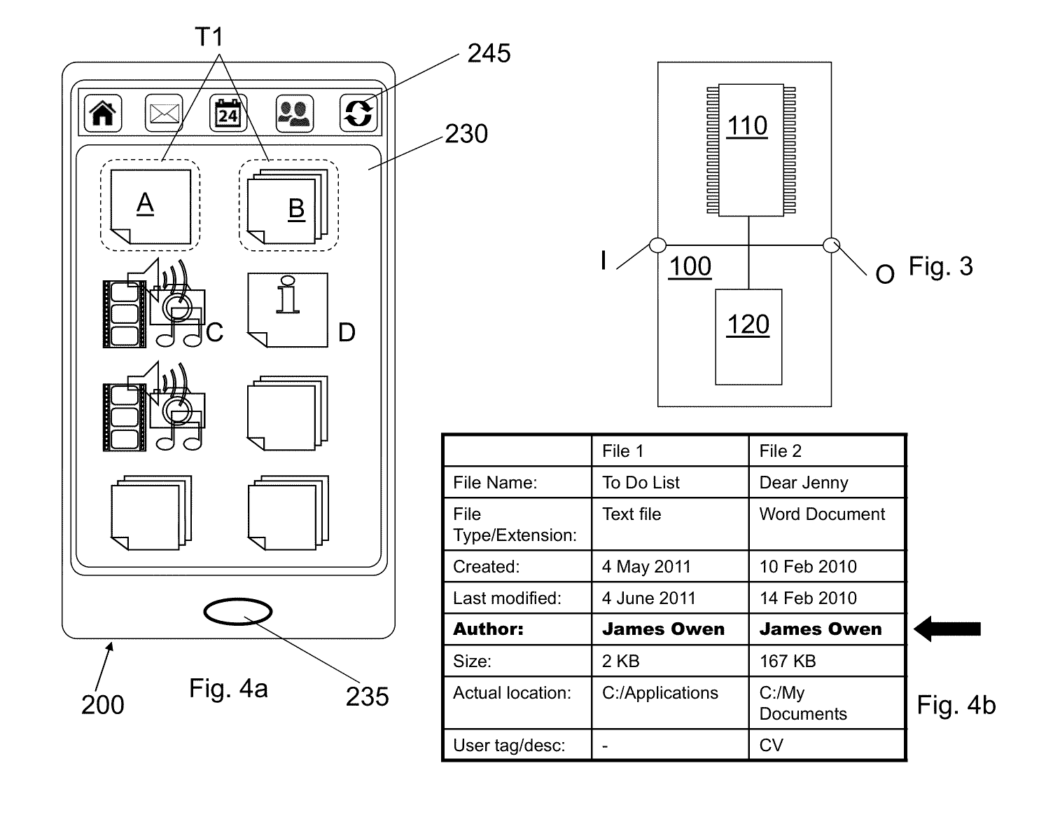

We will now describe a first embodiment with reference to FIG. 3. FIG. 3 shows an apparatus 100 comprising a processor 110, memory 120, input I and output O. In this embodiment only one processor and one memory are shown but it will be appreciated that other embodiments may utilise more than one processor and/or more than one memory.

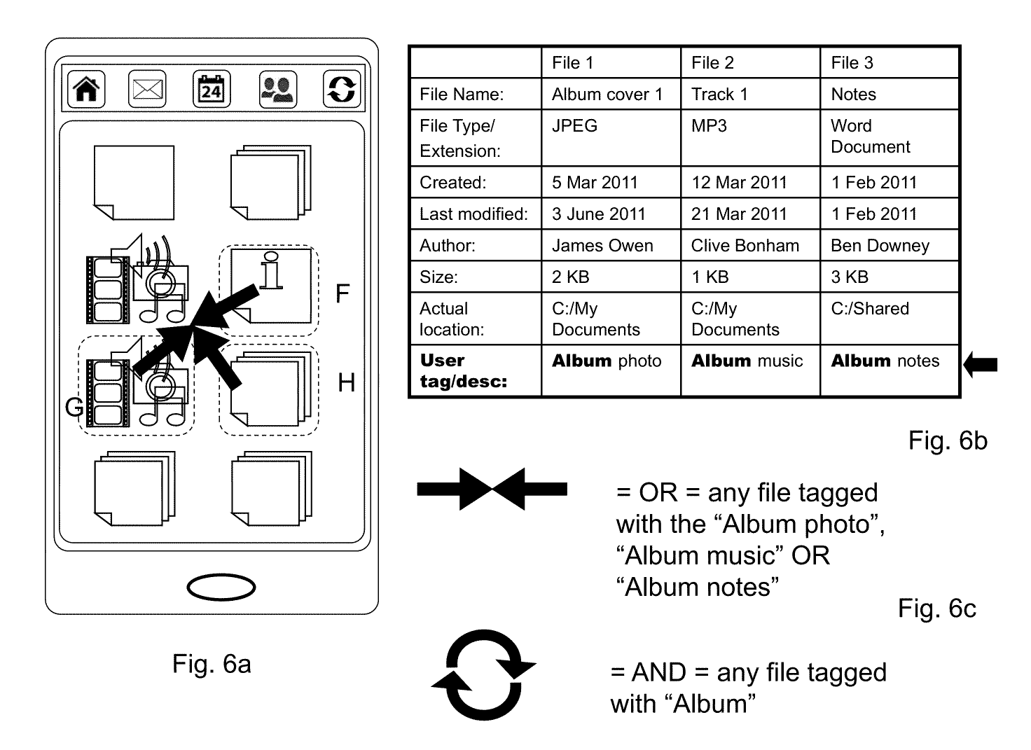

In this embodiment the apparatus 100 is an application specific integrated circuit (ASIC) for a portable electronic device 200 with a touch sensitive display 230 as per FIG. 6b. In other embodiments the apparatus 100 can be a module for such a device, or may be the device itself, wherein the processor 110 is a general purpose CPU of the device 200 and the memory 120 is general purpose memory comprised by the device 200.

The input I allows for receipt of signalling to the apparatus 100 from further components, such as components of a portable electronic device 200 (like the touch-sensitive display 230) or the like. The output O allows for onward provision of signalling from within the apparatus 100 to further components. In this embodiment the input I and output O are part of a connection bus that allows for connection of the apparatus 100 to further components.

The processor 110 is a general purpose processor dedicated to executing/processing information received via the input I in accordance with instructions stored in the form of computer program code on the memory 120. The output signalling generated by such operations from the processor 110 is provided onwards to further components via the output O.

The memory 120 is a computer readable medium (solid state memory in this example, but may be other types of memory such as a hard drive) that stores computer program code. This computer program code stores instructions that are executable by the processor 110, when the program code is run on the processor 110.

In this embodiment the input I, output O, processor 110 and memory 120 are all electrically connected to one another internally to allow for electrical communication between the respective components I, O, 110, 120. In this example the components are all located proximate to one another so as to be formed together as an ASIC, in other words, so as to be integrated together as a single chip/circuit that can be installed into an electronic device (such as device 200—see FIG. 4a). In other embodiments one or more or all of the components may be located separately from one another (for example, throughout a portable electronic device like device 200). In other embodiments, the functionality offered by each of the components may be shared by other functions of a given device, or the functionality required by each of the components may be provided by components of a given device.

The operation of the present embodiment will now be described, and the functionality of the computer program code will be explained.

In this embodiment, the apparatus 100 is integrated as part of a portable electronic device 200 as shown in FIG. 4a. The device 200 has a touch-sensitive display 230 (also known as a touch-screen display) and also a physical ‘home’ button/key 235. These are the only two components of the device 200 that are able to receive input from the user on the front face of the device 200. In this or other embodiments, further buttons/keys may be provided on other surfaces, e.g. to control volume, or physical shortcut keys.

The display 230 provides various portions of visual user output from the device 200 to the user. For example, in this example the display 230 provides shortcut keys 245 to various functions/applications that a user can press to access those other functions/applications whilst in another application or using another function. The device display 230 is also configured to provide content on the display associated with at least one running application. A user can operate the touch-sensitive display 230 via direct touch with their finger or a styles, etc. In some cases, the user can operate the display 230 and generate ‘touch’ signalling simply by hovering their finger over the display 230 but not actually directly touching the display 230.

As shown in FIG. 4a, device 200 is displaying a number of icons as part of a collection of files that the user has entered while browsing the memory of the device 200. These icons are graphical representations of the files stored on the memory. In this example, the icons represent both actual files and shortcuts to actual files stored within the same folder, but it will be appreciated that there can be other folders with other files stored therein that are part of a storage hierarchy on the memory of the device 200.

Icon A represents a text file (e.g. *.txt or *.rtf extension). Icon B represents a word file (*.doc extension). Icon C represent a media file (audio like MP3, AAC, WAV, etc; video like MPG, MP4, WMV, etc; etc), while Icon D represents an image file (e.g. *.GIF, *.JPEG, etc). Other icons representing other types of files, shortcuts or folders are of course possible and just a small subset is shown here for explanatory purposes.

To give this example some context, we shall say that the user is looking for a specific text document that he knows he has created. He cannot remember any exact wording from the document or anything within the document itself. All he can remember is that he created it at some point. This would make him the ‘Author’ of that document. Current portable electronic devices store facts like this (e.g. who created the file, the date it was created, the date it was last modified, the file extension, any user tag/description, hidden file attributes, etc) as metadata associated with the file. For example, on a desktop personal computer or laptop a user can right-click on an icon and click ‘Properties’ to view just some of the peripheral information associated with the file that the icon graphically represents. These peripheral facts are called ‘metadata’ and these aspects and can be configured to represent anything that could be used to search for a file.

For example, MP3 files and other types of music/audio file utilise ‘ID3’ tags that store information relating to that particular music file, such as the artists and/or band, band members, who wrote the piece, when it was recorded, where it was recorded, the quality/sampling rate of the recording, whether it is locked, whether it is unlocked, invisible, read-only, etc. Metadata can include any and all of these things and has the potential to store many other facts about various files or folders.

Another example is in the area of electronic books, which would enable the user to find electronic book (files) from a particular author, publisher, or genre, as an example by selecting two or more books/files that share that common metadata aspect for which they are looking.

In the example of FIGS. 4a and 4b, the user is looking for a particular document that he knows he created and therefore ‘authored’. The user happens to know that the files associated with icons A and B were also documents created by him at some point, and so they must have his authorship in common as a metadata aspect. Therefore the user can designate these content items (in this case two, but the user could designate more) by way of gesture command signalling so that the apparatus 100 will identify the ‘author’ as the common metadata aspect between the two content items. The apparatus 100 will then use this common ‘author’ metadata of ‘author=‘James Owen’ as the common metadata aspect on which the search for other content items is to be based. This means that the search is performed for other content items that share the authorship, i.e. the author tag must contain content of ‘James Owen’ to meet the criteria of the search, thereby restricting out any content items that do not share his authorship.

Therefore, in this example the user has, via touch signalling T1, touched both icon A and icon B with respective digits of one of his hands. The touch-sensitive display 230 generates touch signalling in accordance with the sensed touching of icons A and B. Because the user has touched in two places at once rather than just in one place, the touch signalling will be identified as atypical of normal single digit operation of the device. When multiple touches/multi-touches occur, these are identified as ‘gestures’ as they represent touch signalling that is distinct from more standard operation of the device. As a result, the touch signalling can be understood to constitute gesture command signalling.

The apparatus 100, based on this gesture command signalling, needs to identify a common metadata aspect or aspects between the files associated with icon A and icon B. FIG. 4b shows a comparison table in relation to this.

FIG. 4b shows the various metadata aspects/attributes of the two files compared side by side. The metadata content can be stored in respective separate metadata files for File 1 and File 2, be stored together with the content of File 1 and File 2 (e.g. delineated as metadata as part of the overall content item, but separate from the actual content of such a file), or somehow otherwise linked/associated to the content of File 1 and File 2. As can be seen, they are different types of file, differently named, different sizes, different actual locations, different creation dates, different last modified dates, etc. However, there is one metadata aspect that they have in common. The two files were created by the same author, by user ‘James Owen’. This metadata aspect of the author being ‘James Owen’ has been identified by the apparatus 100 as the one common metadata aspect between the files.

In essence, the metadata content stored within a given tag can constitute the common aspect of metadata. For example, a first file has the tag ‘name=Paris’ and a second file has the tag ‘location=Paris’, and so the common aspect of metadata can be the metadata word ‘Paris’. Also, the metadata stored within a tag together with the category of tag itself can constitute the common aspect of metadata. For example, sticking with the example of the first and second files mentioned above, the search can be performed for any file that matches ‘name=Paris’ or that matches ‘location=Paris’ (or both). In another example, like the present embodiment, a common metadata aspect might be identified between two files where the ‘author=James Owen’, therefore only files that match this are searched for.

In the present embodiment, using this information identified from the files selected by the user, the apparatus 100 performs a search for other content items using that common metadata aspect. In this case, the apparatus 100 will search for other content items on the entirety of the device that matches the criterion that the author is ‘James Owen’, i.e. ‘author=James Owen’. In other examples, the search can be restricted (e.g. by a user preference or default setting) to only search the current folder, or sub-folders below that folder in the hierarchy, or a set number of levels/branches away (either sub- or super-folders, etc) or the like. The search can also be conducted on content items to which the apparatus has direct access to and/or indirect access to (e.g. via a cloud server or the like). For example, the search could be performed not on (or not just on) the files located locally on the device, but could form the basis of an Internet search (e.g. using Google™, or the like).

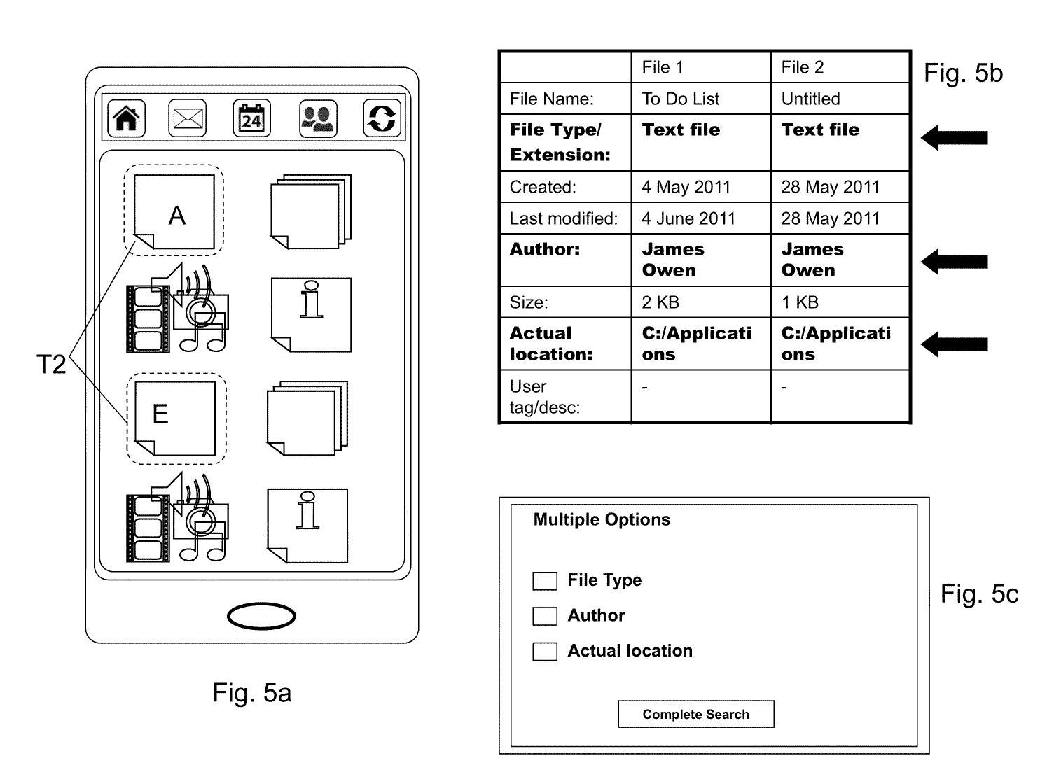

The results from the search can then be presented in various ways, but for the purposes of this embodiment we shall show that the results are displayed in the same/similar fashion to the way that icons within a given folder would normally be displayed in response to a user opening that folder. This is illustrated in FIG. 5a.

At this stage the user (who we know to be ‘James Owen’) remembers that it is a text file, and not a word document, that he created and that he is trying to find. In the presented results, original icon A has been returned (as it was used in the initial search parameters), and there is also new icon E that also represents a text file in the same way as icon A does.

Because the results are presented onscreen in FIG. 5a in substantially a similar way to the way the icons were presented in FIG. 4a, the user can actually invoke the search mechanism of the apparatus 100 again by touching two or more content items that he wishes to use to perform a search. This can therefore allow a user to further refine their search parameters and get more specific results, or to even abandon certain parameters that were used in earlier search iterations. In this example of FIG. 5a the user touches icon A and icon E simultaneously or one touch occurring shortly after the other (touch signalling T2) to cause the apparatus 100 to, based on the command gesture signalling indicated by touch signalling T2, identify one or more common data aspects between the two files. FIG. 5b shows this comparison while the common metadata aspects are being identified.

FIG. 5b shows that, unlike the identification stage of FIG. 4b, there are multiple common data aspects. Obviously the files will have the authorship in common by virtue of the earlier search, but it also happens that the two files are also text files and that they are stored in the same folder location on the memory of the device 200. At this stage, it is not necessarily apparent to the device 200 which metadata aspects are to be used to perform the search. Obviously more than one metadata aspect can be used, but the user may not wish for all of them to be used, and may even wish to remove one of the earlier restrictions (for example, if he began to doubt whether he created that document or not, then the user may wish to remove that search criterion from the search parameters).

As shown in FIG. 5b, the apparatus 100 has identified that multiple common metadata aspects are present. In response to this, the apparatus 100 provides the user with the opportunity to select a particular common metadata aspect for use in the search. The apparatus 100 can then use the selected common metadata aspect as the (one or more) identified common metadata aspect(s) to search for other content items with the same metadata in common. FIG. 5c shows that a dialog box is brought up to allow the user to select which common metadata aspects they wish for the search to incorporate. The user can select a checkbox for one or more of the particular search requirements to further refine the search.

In this example, the user selects the ‘Author’ and ‘File Type’ checkboxes to further refine the search. The user does not select (nor needs to select) the ‘Actual Location’ checkbox as he is not certain that the text file created by him is stored in the same location as the other text files, and so does not want to exclude other text files from being generated in response to the further search.

This would mean that the search results would consist only of ‘text files’ authored by ‘James Owen’ and the user can then peruse the search results to locate that particular file. He could of course perform further searches in the manner described above by performing gestures that designate multiple content items, but there is no requirement to do so.

In the examples above, the search was conducted on the basis of the tag category together with the metadata content of the tag, i.e. ‘author=‘James Owen’’ was the search criteria/common metadata aspect being searched. However, it will be appreciated that this need not always be the case. For example, the user, or a service provider, could configure the apparatus such that the common metadata aspect that is used as the basis of the search does not require the tag category to match also. In effect, if the user configured the device of FIG. 4a in such a way, then the search would be performed for other content items that had any tag category containing content that recited ‘James Owen’. As a result, there may be content items that were not authored by James Owen but had been later modified by James Owen, and so the tag category of ‘Last Modified’ (this category is not shown) would match the search criteria, and would therefore be returned in the search results.

It should be noted that in some cases a user may select two or more content items for which there is no common metadata aspect whatsoever. In such an example, the search function could return a message or error readout saying ‘No results’ or ‘No matching search results’. The apparatus could also be configured to allow a user to modify their search parameters manually if no search results are returned (e.g. to give the user the opportunity to reconfigure the device from requiring a match for both common tag category and tag content to match, to just requiring any tag category to have common tag content).

In another embodiment the user can be browsing a collection of files within which there are a variety of email files and a variety of image files. The image files contain metadata that says who is in each of the photos, and the emails also contain metadata that indicates the addresses and names of the sender and the receiver(s). In this embodiment, sender and receiver information can be understood to constitute metadata as it provides information about the content of a given content item. This metadata may be stored separately in a metadata file, or delineated as metacontent/descriptive metadata within the code of a given content item/file. The email files could form part of an email thread or be part of a folder containing emails. Similarly the images could form part of a gallery, or a folder containing those images.

When the user selects at least one email and at least one image, despite the file type differences the search can be performed based on identified common metadata aspect(s) between the files. For example, a search could be performed based on a selected email and image such that only images where the senders/receivers of the emails are present would be returned as search results.

It is possible in some embodiments that a user can gesture an icon that represents a collection of content items, i.e. a single icon is representative of multiple content items. As a result, gesturing of such an icon per se can lead to searching based on content items associated with that icon in a similar manner to that described above.

Also, in the above examples of the figures, the user touched two content items, and touched them in a straightforward manner. The embodiments of the present disclosure are not limited to use with just two content items. More than two content items can be touched by a user in order to generate more precise/refined searches. Secondly, gestures that generate gesture command signalling need not be restricted to only touching the items on which the search is to be based. Instead, gestures can incorporate movement of the user's fingers to scribe out particular shapes on the screen. The purpose behind this is that particular gestures can have information associated with each of them. In particular, a given gesture can be associated with a particular search type that will affect how the search to be performed by the apparatus is then executed.

FIG. 6a shows an example that illustrates both of these points. In FIGS. 4a/5a and 4b/5b, the user just touched both icons A and B simultaneously (or almost simultaneously, as the user may touch down one finger slightly before the other). In FIG. 6a, the user has touched icons F, G, and H substantially simultaneously, and has then drawn his/her fingers together (as indicated by the arrows). This particular gesture will generate unique touch signalling characteristic of that particular gesture at the display 230 of the device 200, which will in turn be indicative of particular gesture command signalling for the apparatus 100. In this example, the particular gesture of drawing the fingers in a ‘pinch’ gesture together designates a logical operation for the search—namely an ‘OR’ operation. Other gestures and logical operations or search types are also possible. For example, in the example that a ‘push’ or ‘slide’ gesture is performed (sliding the fingers in a substantially linear line across the display 230) will cause the search to only be performed for content items directly associated with that container (or folder) within which those identified content items are stored. Another different/particular gesture may initiate a search type where the entire device memory is searched, and the search is not limited to any one folder/container. We will describe such search types and restrictions in more detail below in the context of the example of FIG. 6a-c.

In this example, the only common metadata aspect (as shown in FIG. 6b) is that there is a common word ‘Album’ in each of the user tags/descriptions of each file. In such a scenario, the user tag/description ‘Album’ is the common metadata aspect that is used as the basis for a search for other content items with user tag/description metadata that contains the word ‘Album’.

With regard to the particular gesture signalling and the associated search type, the ‘OR’ logical operation will restrict the search to only those items that have the common search terms “Album photo” OR “Album music” OR “Album notes”. This is illustrated in FIG. 6c.

Alternatively, as is shown in FIG. 6c, another gesture (fingers scribe out a circle in a clockwise direction) designates a search type of a logical operation ‘AND’. In this example, only the common metadata aspect is used as the search criterion—i.e. user tag/description containing the word ‘Album’. Obviously in this example that could result in more search results for the ‘AND’ search than the ‘OR’ search, but of course it may be the other way round depending on the nature of the AND/OR search query/restriction of a given scenario.

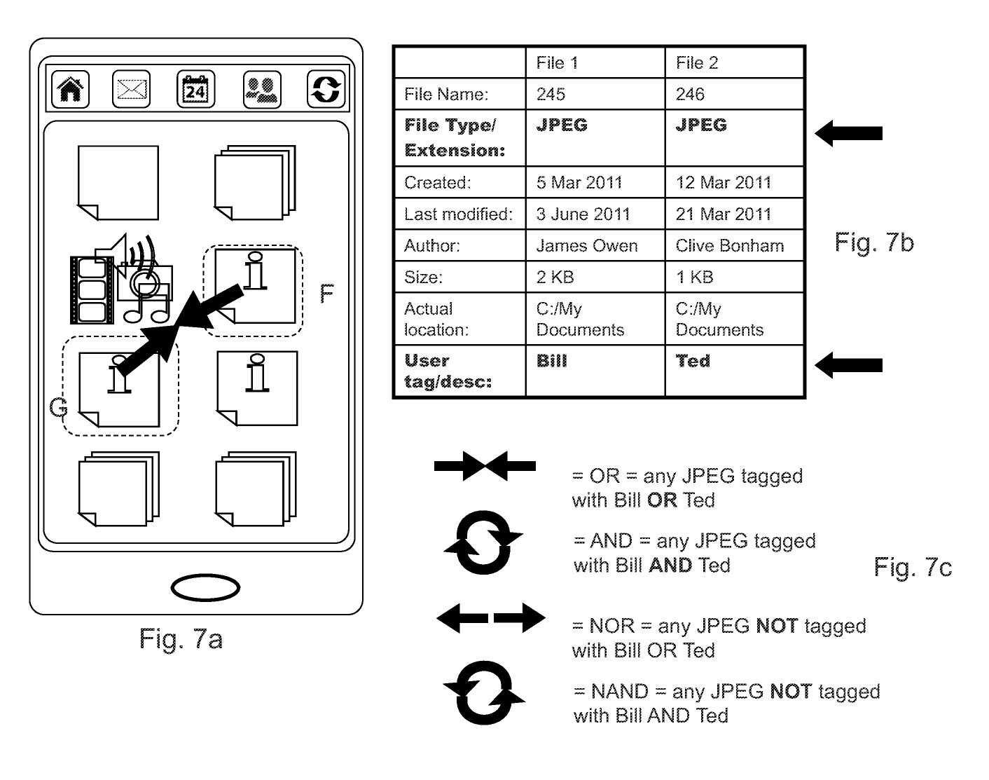

FIG. 7a shows another example where a user draws their fingers together while selecting two images. In this example, the apparatus 100 is configured to, in response to identifying commonality between the file type metadata aspect, assume that the user is looking for files of that type and treat this as a first metadata aspect to perform the search on. The apparatus 100 can be configured to automatically assume a user is looking for a particular file type when a user selects two files of the same type and add this as an automatic search criterion, or this may only be done for certain file types (e.g. automatic search criterion when two images or music files are selected, but not automatic for two word documents, etc).

However, the apparatus 100 also assumes that the user is interested in the user tag/description metadata as the images are likely to have information associated therewith, e.g. names of people, the model of camera that took the photos, geolocation of where the photo was taken, etc. In this example, the user tag/description identifies that the first picture is of ‘Bill’ and the second is of ‘Ted’.

The gesture is of drawing the fingers together in a ‘pinch’ gesture, so the search type is an ‘OR’ search. Therefore, the apparatus 100 knows to perform a search for images that have either ‘Bill’ OR ‘Ted’ in them. Likewise, if the gesture was a clockwise rotation of the fingers, the apparatus 100 would perform a search for images that have both ‘Bill’ AND ‘Ted’ in them.

It will be appreciated that other search types or logical operations may be desirable by a user. For example, if they want all images that do not have a particular metadata aspect in common. FIG. 7c shows illustrations of other gestures that could perform other logical operations, where an anticlockwise circle could indicate a ‘NAND’ operation where only images that do not have ‘Bill’ AND ‘Ted’ in are returned. Alternatively, a gesture of the fingers being moved away from one another could result in a ‘NOR’ operation, where only images that do not have ‘Bill’ OR ‘Ted’ are returned.

In the earlier example of FIGS. 4a-b and 5a-c, the user merely ‘marked’ the content items that he wished to use in a search. In another example, the apparatus 100 is configured to allow a user to select the content items they are interested in using, remove their fingers from the screen, then perform a particular gesture to determine the type of search to be performed. This is effectively a combination of the embodiments of FIGS. 4a-b and 5a-c together with the embodiments of FIGS. 6a-c and 7a-c.

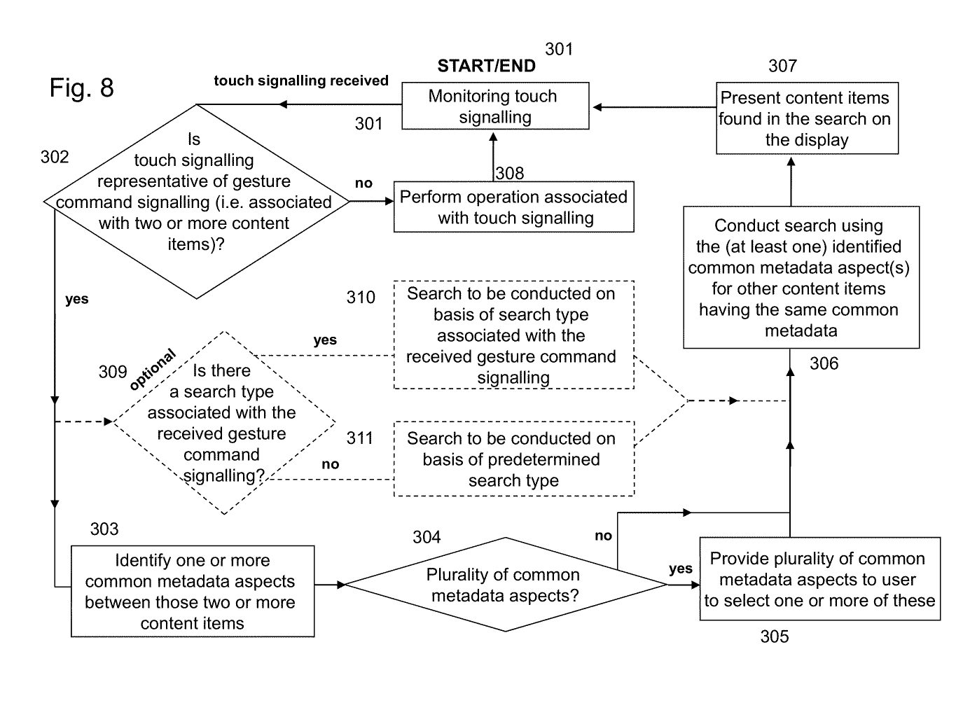

In a further modification of these embodiments, a user could select the content items (as per the paragraph above), and then not perform any specific gesture that has a predetermined search associated therewith. In this example, once a predetermined time (e.g. a few seconds, or until other user input is received, etc) has elapsed the apparatus 100 decides that no gesture has been or will be received, and therefore performs a predetermined search type. All of the touch signalling received, whether in one or two or more stages, can be considered to constitute gesture command signalling, it is simply a question of whether that collective gesture command signalling has a search type associated with it, or whether a predetermined search type needs to be used. This is encompassed by the method of FIG. 8 (described below).

In summary, by identifying one or more common metadata aspects for two or more content items as indicated by received gesture command signalling, it is possible for a user to intuitively perform a tailored search request without having to go into a menu layer to do so. In addition this allows direct interaction between the files/representations of the files and the user, thereby providing a more interactive and easy to use file representation interface for a user.

FIG. 8 illustrates a method of operation that corresponds to one or more of the described embodiments.

Firstly, the apparatus 100 (or even the device 200 separately) is monitoring the touch signalling that might be received via the display 230 (at step 301). In response to receipt of touch signalling, it is necessary to establish whether the touch signalling is representative of gesture command signalling, i.e. in relation to or associated with two or more content items (step 302).

If the touch signalling is just general touch signalling and not representative of gesture command signalling, then step 308 simply executes the operation associated with that touch signalling (whatever that may be) and the method returns to the waiting state for monitoring touch signalling at step 301.

If the touch signalling does represent gesture command signalling, then the method proceeds to step 303. There is an optional branch that can be used in embodiments that utilise gesture signalling (branch 309, 310, 311) that occurs in parallel with the branch beginning with 303, but we will describe this in more detail later.

Step 303 performs identification of one or more common metadata aspects between the two or more content items. As has been discussed above, such metadata aspects could be file type, author, actual location, artist, track number, album etc, essentially any data that could be used for searching purposes, or that otherwise tells observers (e.g. user, operating system) something about the attributes of the file.

Step 304 assesses whether there are a plurality of common metadata aspects. If the answer is ‘no’ then there is only one common metadata aspect and the method proceeds to step 306. If the answer is ‘yes’ then it will be necessary to provide the user with an opportunity to select which metadata aspects they wish to use in the search. This could just be one metadata aspect, but the user could select any number of the identified common metadata aspects to be used as the basis for the search.

Step 306 then performs the search based on the at least one identifier common metadata aspect, in order to find other content items with this common metadata aspect.

Step 307 presents the content items found in the search on the display and the method returns to the waiting state of monitoring touch signalling at step 301. Because the results can be provided on the display 230, this means that if a user were to provide further gesture command signalling in relation to two or more of those content items then a further search could be performed on the basis of any common metadata aspects between two or more content items as provided in the earlier search. This could form the basis of a completely fresh search, or act as a further refinement of the earlier search, or as a modification of the earlier search parameters (e.g. removal/addition of common metadata aspects to the search criteria).

Looking at the optional branch, as has been discussed above, particular gesture command signalling can have a particular search type associated with that particular gesture. This means that if a user performs a gesture such as twisting/rotating their fingers on screen whilst selecting two or more of the presented content items, then it is necessary to establish the nature of the search the user wishes to perform given their gesture. In the examples above a twisting gesture means an ‘AND’ search type, while a gesture of moving the fingers apart means a ‘NOR’ search type etc. However, a user may use a gesture that has no specifically assigned or associated search type, e.g. just tapping two icons once, or double tapping two icons. It is therefore helpful to have some kind of distinction between the two. Therefore, step 309 asks if there is a search type associated with the gesture signalling.

If the answer is ‘yes’ then the search type associated with that gesture signalling is used as the basis for the search in the manner described above (like FIGS. 6a-c and 7a-c). If the answer is ‘no’ then a predetermined search type is used as the basis for the search, in a fashion similar to FIGS. 4a-b and 5a-c. This predetermined search type could be preset as part of the operating system, or could be user-settable, or both. This means that regardless of which gesture the user intentionally (or accidentally) uses, results should still be generated regardless.

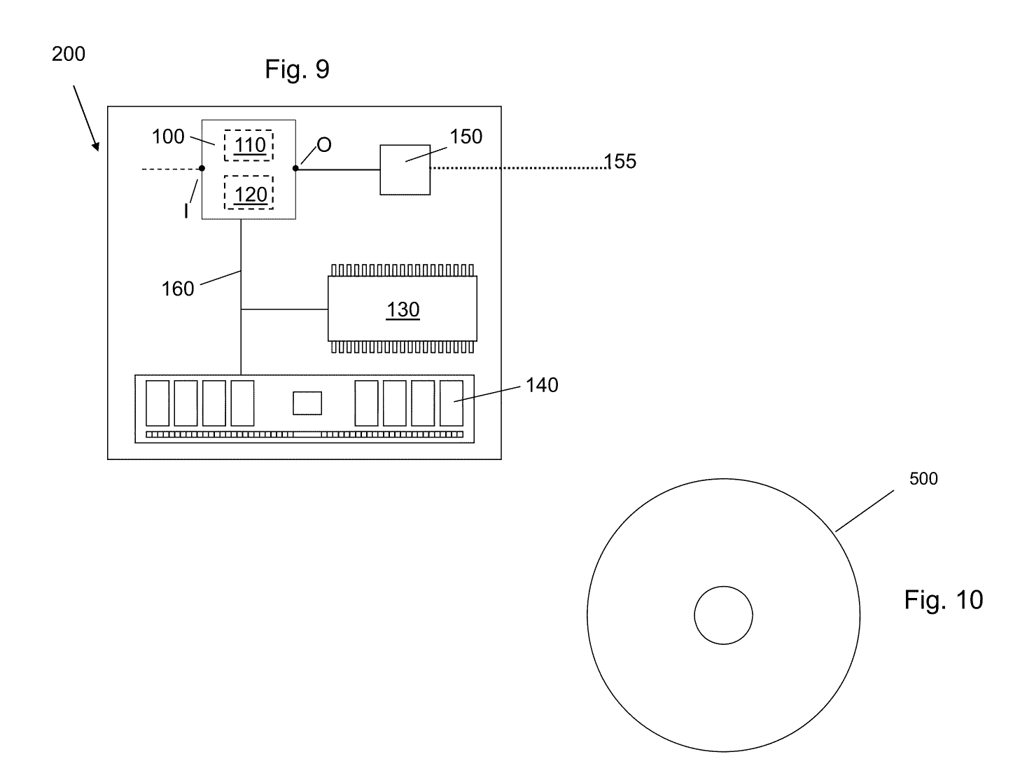

FIG. 9 illustrates how the apparatus 100 of FIG. 7 can be implemented in an electronic device 200. FIG. 8 illustrates schematically a device 200 comprising the apparatus 100 as per any of the embodiments described above. The input I is connected to a touch-sensitive display that provides information to the apparatus 100 regarding touch signalling received by the touch-sensitive display. The output O is connected to a display controller 150 to allow the apparatus 100 to control the position of the cursor or indicator as well as the magnified view presented on the display 230. The display controller 150 is also able to be connected to a different display 155 of another electronic device that is different to device 200.

The device 200 may be an electronic device (including a tablet personal computer), a portable electronic device, a portable telecommunications device, or a module for any of the aforementioned devices. The apparatus 100 can be provided as a module for such a device 200, or even as a processor for the device 200 or a processor for a module for such a device 200. The device 200 also comprises a processor 130 and a storage medium 140, which may be electrically connected to one another by a data bus 160.

The processor 130 is configured for general operation of the apparatus 100 by providing signalling to, and receiving signalling from, the other device components to manage their operation.

The storage medium 140 is configured to store computer code configured to perform, control or enable the making and/or operation of the apparatus 100. The storage medium 140 may also be configured to store settings for the other device components. The processor 130 may access the storage medium 140 to retrieve the component settings in order to manage the operation of the other device components. The storage medium 140 may be a temporary storage medium such as a volatile random access memory. On the other hand, the storage medium 140 may be a permanent storage medium such as a hard disk drive, a flash memory, or a non-volatile random access memory.

FIG. 10 illustrates schematically a computer/processor readable media 500 providing a program according to an embodiment of the present invention. In this example, the computer/processor readable media is a disc such as a digital versatile disc (DVD) or a compact disc (CD). In other embodiments, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code being configured to, with the at least one processor, cause the apparatus to perform at least the following:
identify, based on received gesture command signalling associated with two or more content items, one or more common aspects of metadata for those two or more content items; and
use an identified common aspect of said metadata to search for other content items with metadata in common to the identified common aspect of metadata.

2. The apparatus of claim 1, wherein the at least one memory and the computer program code are configured to, with the at least one processor, cause the apparatus to:
provide user access to the other content items with metadata in common to the identified common aspect of metadata.

3. The apparatus of claim 1, wherein the at least one memory and the computer program code are configured to, with the at least one processor, cause the apparatus to:
use the identified common aspect of metadata to perform filter searching of metadata of other content items to identify other content items with metadata in common to the identified common aspect of metadata.

4. The apparatus of claim 1, wherein the at least one memory and the computer program code are configured to, with the at least one processor, cause the apparatus to:
in response to multiple common metadata aspects being identified for the two or more content items, provide the user with the opportunity to select a particular common metadata aspect for use in the search, and use the selected common metadata aspect as the identified common aspect of metadata to search for other content items with metadata in common to the identified common metadata aspect.

5. The apparatus of claim 1, wherein the search is limited to being conducted in a container that is associated with the two or more content items.

6. The apparatus of claim 1, wherein the search is limited to being conducted in the particular container containing the two or more content items.

7. The apparatus of claim 1, wherein the search is limited to being conducted in one or more particular containers based on the particular gesture command signalling received.

8. The apparatus of claim 1, wherein the at least one memory and the computer program code are configured to, with the at least one processor, cause the apparatus to:
perform a particular type of searching associated with the particular gesture command signalling to provide for user access to other content items with metadata in common to the identified common aspects of metadata.

9. The apparatus of claim 1, wherein the at least one memory and the computer program code are configured to, with the at least one processor, cause the apparatus to:
perform a predetermined type of searching to provide for user access to other content items with metadata in common to the identified common aspects of metadata in the event that particular gesture command signalling does not have a particular type of searching associated therewith.

10. The apparatus of claim 8, wherein the particular search type associated with particular gesture command signalling is an:
AND logical operation, OR logical operation, NOR logical operation, or NAND logical operation.

11. The apparatus of claim 8, wherein the association between particular gesture command signalling and particular search types is settable by a user, or set by default.

12. The apparatus of claim 1, wherein user access comprises at least displaying of said one or more other content items.

13. The apparatus of claim 1, wherein the at least one memory and the computer program code are configured to, with the at least one processor, cause the apparatus to:
receive gesture command signalling from a touch-sensitive display of an electronic device, the gesture command signalling being generated in response to a user operating said touch-sensitive display.

14. The apparatus of claim 1, wherein the other content items provided by the search are provided on a user interface comprised by the same device as that which received the gesture command signalling or a different device to that which received the gesture command signalling.

15. The apparatus of claim 1, wherein metadata tags comprise one or more of the following categories:
names, titles, tags, artists, albums, people, group, originating program, originating author, last modified date, created date, last moved date, modification history, modified by who, created by who, moved by who, sender, receiver(s), and geo-tags.

16. The apparatus of claim 1, wherein the common metadata aspect used for the search is the common metadata content across the same common metadata tag category of the two or more content items.

17. The apparatus of claim 1, wherein the common metadata aspect used for the search is the common metadata content across one or more of the same and different metadata tag categories of the two or more content items.

18. The apparatus of claim 1, therein the apparatus is one or more of:
an electronic device, a portable electronic device, a module for an electronic device, and a module for a portable electronic device.

19. A method, comprising:
identifying, based on received gesture command signalling associated with two or more content items, one or more common aspects of metadata for those two or more content items; and
using an identified common aspect of said metadata to search for other content items with metadata in common to the identified common aspect of metadata.

20. A non-transitory computer readable medium, comprising computer program code stored thereon, the computer program code being configured to, when run on at least one processor, perform at least the following:
identifying, based on received gesture command signalling associated with two or more content items, one or more common aspects of metadata for those two or more content items; and
using an identified common aspect of said metadata to search for other content items with metadata in common to the identified common aspect of metadata.
